(19) United States
(12) Patent Application Publication
(10) Pub. No.: US 2017/0303508 A1
(43) Pub. Date: Oct. 26, 2017

(54) Cat Toy with Pronged Mounting Base

(71) Applicant: The KONG Company, LLC, Golden, CO (US)

(72) Inventor: John James Stone, Golden, CO (US)

(73) Assignee: The KONG Company, LLC, Golden, CO (US)

(21) Appl. No.: 15/135,356

(22) Filed: Apr. 21, 2016

(51) Int. Cl. A01K 15/02; F16M 13/02

(52) U.S. Cl. CPC A01K 15/025; F16M 13/022

(57) ABSTRACT

The pet toy comprises a body having a chamber that may hold attractants. A plurality of openings in the body enables the aroma of an attractant to escape. One end of the body includes a projection that frictionally engages one end of an extension in the form of an elongate spring. The opposite end of the elongate spring connects to a base. The base has a plurality of prongs that extend substantially perpendicular to the base. Each prong has a stem and an arm extending substantially perpendicular to the stem. The pet toy is mounted to a surface having gaps between layers of material, such as cardboard. The prongs are oriented to engage the surface so sufficient frictional engagement is achieved to keep the pet toy mounted when an animal makes contact with the pet toy.

### FIELD OF THE INVENTION

The invention relates to pet toys, and more particularly, to a cat toy with a base that is especially adapted for mounting to material such as cardboard.

### BACKGROUND OF THE INVENTION

Due to the increased commercialization of pet products and particularly pet toys, there are now a wide range of commercially available pet toys with distinct functions. Pet toys can be made from many different types of materials along with a nearly limitless number of shapes and colors.

The most popular pet toys are dog and cat toys, primarily because these remain the most common pets. There is some overlap between dog and cat toys, that is, some pet toys can be used for both dogs and cats. For example, plush toys are commonly sold for both dogs and cats.

One particular type of pet toy unique for cat toys is one that includes a flexible wand or spring that may dangle an attractant such as a plush toy with catnip, feather, or other attractant. The wand or spring provides an unpredictable and random motion for the attractant which draws the attention of a cat.

One particular drawback for these types of cat toys is that the flexible wand or spring must be held by the pet owner to generate play with the cat. Alternatively, the flexible wand or spring may have a stationary mounting base, but because of the potential force that a cat may transfer to the wand or spring, the mounting base must be large and have sufficient weight to withstand the force which therefore makes the toy too large for easy storage. For these reasons, these types of cat toys are not convenient solutions for entertaining an animal such as a cat.

### SUMMARY OF THE INVENTION

According to the invention, a cat toy is provided with an improved mounting base that may be inserted into a surface that is penetrable with reasonable force applied to insert the mounting base into the surface. According to a special feature of the invention, the mounting base is configured with a plurality of spaced prongs with pointed distal tips that enable the mounting base to be inserted into a surface such as a corrugated material including cardboard.

More particularly, the mounting base includes spaced prongs that are sized such that they frictionally engage the flutes of a cat scratcher made of cardboard material. Cardboard cat scratchers are one type of known material for use with cat scratching devices such as scratching posts or scratching boards. Cardboard material typically includes parallel sheets of relatively thick paper material that are glued to a corrugated or wavy inner medium, sometimes referred to as fluting. For a cat scratching board or post made of cardboard, there is a gap between the corrugated inner medium or layer and the adjacent sheet of paper material. The spaced prongs of the mounting base are sized and spaced so that the prongs may be conveniently inserted in the gaps of the cardboard material, and the increasing width of the prongs as they are inserted within the gaps allows them to be firmly engaged with the corrugated fluting and the parallel sheets of material. The firm engagement between the prongs and the layers of cardboard material result in the cat toy being sufficiently secured to the cardboard material so that a cat playing with the toy can apply considerable force to the cat toy without dislodging the mounting base from the cardboard material.

According to a preferred embodiment of the invention, the prongs of the mounting base may have a generally “T” shaped cross-section. When a prong is inserted within cardboard material, the prong is preferably inserted into the cardboard material such that the stem of the “T” projects substantially perpendicular to one of the parallel sheets of material and the arm of the “T” extends substantially parallel to the sheet. In this way, the stem and arm of the “T” frictionally engages material of the cardboard and therefore, the prong remains sufficiently frictionally engaged to withstand force applied against the mounting base to prevent it from being dislodged.

The mounting base may include a desired number of prongs along with a spacing of the prongs such that engagement of the mounting base with cardboard material is optimized for frictional contact with the cardboard material for holding the mounting base in place.

Also according to preferred embodiments of the invention, a flexible, spring-like, and/or elastomeric extension may protrude from the mounting base, and an attractant is secured to the free end of the extension in order to attract an animal such as a cat. In one particular preferred embodiment, the extension may include a spring, and the attractant may include a receptacle that can store treats to include catnip. Further, the attractant may have a particularly pleasing shape or be constructed of a material which may enhance interaction with a cat. For example, the shape could be that of a mouse or bird, and the materials may include plush fabric, feathers, and others.

According to one aspect of the invention, it may be considered a pet toy comprising: a body having a chamber formed therein; a flexible extension having one end secured to the body; a mounting base secured to an opposite end of the flexible extension, the mounting base including a plurality of spaced prongs, each of the prongs having a stem and an arm extending substantially perpendicular to the stem.

In another aspect of the invention, it may be a pet toy comprising: a body; a flexible extension having one end secured to the body; a mounting base secured to an opposite end of the flexible extension, the mounting base including a plurality of spaced prongs, each of the prongs having a stem and an arm extending substantially perpendicular to the stem, the mounting base is substantially planar and the plurality of spaced prongs extend substantially perpendicular to the mounting base.

According to yet another aspect of the invention, it may be considered a method of entertaining an animal such as a cat, comprising: providing a pet toy including a body, a flexible extension having one end secured to the body, a mounting base secured to an opposite end of the flexible extension, the mounting base including a plurality of spaced prongs, each of the prongs having a stem and an arm extending substantially perpendicular to the stem; providing a mounting surface; securing the mounting base to the mounting surface by inserting the spaced prongs into the mounting surface such that the flexible extension extends substantially perpendicular to the mounting surface; and providing the pet toy to the animal.

Other features and advantages of the invention will become apparent from a review of the following detailed description, taken in conjunction with the drawings.

### BRIEF DESCRIPTION OF THE DRAWINGS

FIG. 1 is an exploded perspective view of the cat toy according to a preferred embodiment of the invention;

FIG. 2 is a side elevation view of the cat toy;

FIG. 3 is a perspective view of the cat toy with the mounting base of the cat toy secured to an exemplary cat scratching board; and

FIG. 4 is an enlarged fragmentary cross sectional view of the mounting base secured to the cat scratching board showing frictional engagement of the prongs of the mounting base with the sheets and flutes of material making up the cat scratching board.

### DETAILED DESCRIPTION

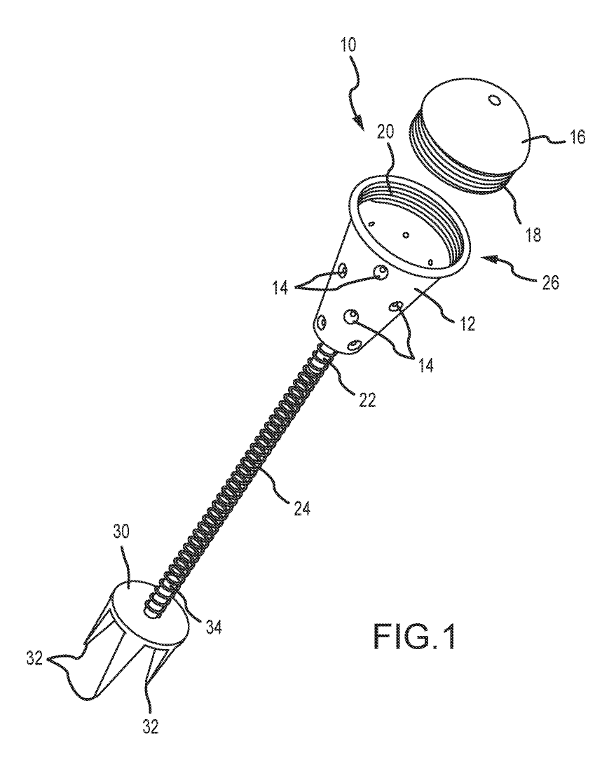

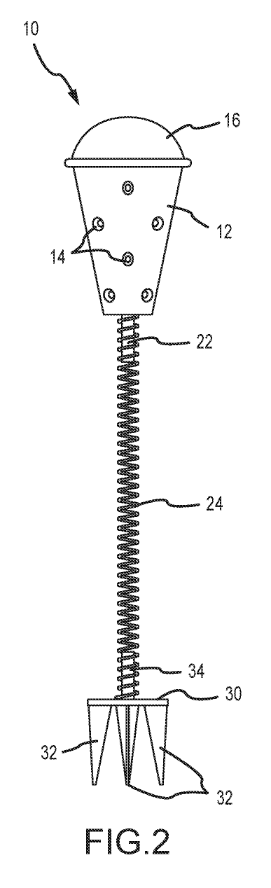

FIGS. 1 and 2 illustrate the pet toy 10 of the invention in a preferred embodiment. The pet toy 10 comprises a body 12 in the form of a receptacle with a chamber 26 that may hold treats or other attractants such as catnip, collectively referred hereinafter as “attractants”. The body 12 may have a plurality of openings 14 to enable the smell or aroma of an attractant to be made available to an animal. The attractants may be loaded through an open end of the body 12, and a cap 16 or other type of closure is engaged with the open upper end, such as by threads 18 and 20 on the cap 16 and body 12, respectively. One end of the body 12 may include a projection or pin 22 that frictionally engages one end of an extension in the form of an elongate spring 24. An opposite end of the elongate spring 24 connects to another projection or pin 34 that extends from a mounting base 30. The pins 22, 34 extend substantially perpendicularly from the body 12 and the mounting base 30, respectively.

The mounting base 30 has a generally circular shape and includes a plurality of prongs or engaging fingers 32 that extend in a direction opposite from the projection 34. The prongs 32 of the base have a generally “T” shaped cross-section as shown. The prongs 32 are arranged such that the stem of the “T” for each prong extends radially inward from the circumferential edge of the mounting base 30. The arms of the “T” for each prong 32 extend along the peripheral or circumferential edge of the base 30.

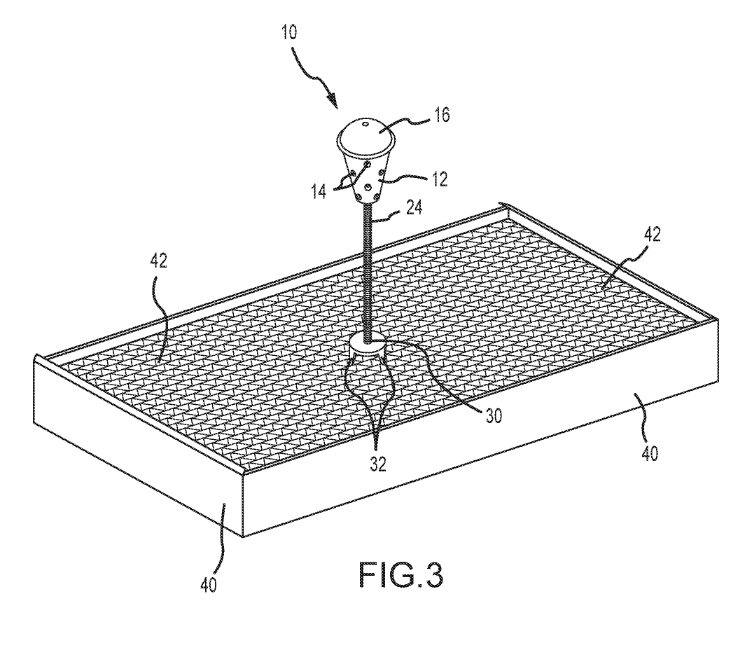

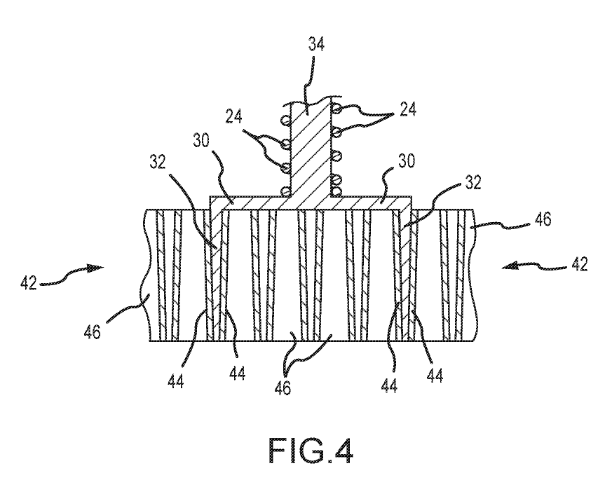

Referring to FIG. 3, the pet toy 10 is illustrated as being mounted to a cat scratching device, such as a scratch box 40. The scratching box 40 is made from composite material 42 such as cardboard. Also referring to FIG. 4, this figure illustrates how the prongs 32 may engage the composite material 42. More specifically, FIG. 4 is intended to represent how the prongs 32 frictionally engage components of the cardboard material 42, these components being shown as one or more sheets of flat cardboard 46 and one or more sheets of corrugated cardboard or flutes 44. As shown, the prongs 32 are spaced so they conveniently fit within the gaps between the corrugated sheets 44 and the flat sheets 46, and also make frictional contact with the sheets 44 and 46 to hold the mounting base 30 in a firm mounting arrangement.

According to a method of the invention, the pet toy 10 is provided. A user selects a mounting surface, such as a scratching box 40. The user orients the prongs 32 to be inserted within corresponding gaps of the scratching box material 42 such that each of the prongs 32 frictionally engage one or more layers or portions 44, 46 of the mounting surface material. The user may slightly twist the mounting base 30 so that the prongs 32 make a preferred frictional engagement with the mounting surface material 42. One or more attractants may be secured within the body chamber 26, and may be loaded therein by removal of a cap 16 or closure. The pet toy 10 is then presented to the animal. The user may observe how the animal interacts with the pet toy 10, and then may adjust how the base 30 is frictionally engaged with the mounting surface 40, either by removing the base and re-mounting it, or slightly twisting or pushing down on the base so that it further engages the mounting surface.

From the foregoing, it is apparent that a pet toy 10 is provided with an improved mounting base 30 which can be effectively secured to surfaces such as those found with many cat scratching devices 40. Accordingly, the pet toy 10 may further enhance an animal's desire to use the scratching device, thereby preventing damage to an owner's furniture or other belongings which the animal may otherwise decide to scratch.

While the invention has been described with respect to a preferred embodiment, it shall be understood that the invention can be modified commensurate with the scope of the claims appended hereto.

What is claimed is:

1. A pet toy comprising:
a body having a chamber formed therein;
a flexible extension having one end secured to said body; and
a mounting base secured to an opposite end of said flexible extension, said mounting base including a plurality of spaced prongs, each of said prongs having a stem and an arm extending substantially perpendicular to said stem.

2. A pet toy, as claimed in claim 1, wherein:
said flexible extension includes a spring.

3. A pet toy, as claimed in claim 1, wherein:
said mounting base is substantially planar and each of said plurality of spaced prongs extends substantially perpendicular to said mounting base.

4. A pet toy, as claimed in claim 1, wherein:
said mounting base is substantially circular;
said spaced prongs extend substantially perpendicular to said mounting base;
at least one stem of said prongs extends radially inward; and
at least one arm extends along a periphery of said mounting base.

5. A pet toy, as claimed in claim 1, further including:
an attractant loaded in said chamber.

6. A pet toy, as claimed in claim 1, further including:
a plurality of openings formed through said body.

7. A pet toy, as claimed in claim 1, further including:
a removable cap secured to said body.

8. A pet toy, as claimed in claim 1, further including:
an attractant loaded in said chamber.

9. A method of entertaining an animal, comprising:
providing a pet toy including a body, a flexible extension having one end secured to said body, a mounting base secured to an opposite end of said flexible extension, said mounting base including a plurality of spaced prongs, each of said prongs having a stem and an arm extending substantially perpendicular to said stem;
providing a mounting surface;
securing the mounting base to the mounting surface by inserting the spaced prongs into the mounting surface such that the flexible extension extends substantially perpendicular to the mounting surface; and
providing the pet toy to the animal.

10. The method, as claimed in claim 9, wherein:
the mounting surface is made from a corrugated material including cardboard, said prongs are inserted in gaps between sheets of material making up said corrugated material, and said prongs make frictional engagement with said sheets of material.

11. The method, as claimed in claim 9, wherein:
said mounting base is substantially circular, said spaced prongs extend substantially perpendicular to said mounting base, at least one stem of said prongs extends radially inward, and at least one arm extends along a periphery of said mounting base.

12. The method, as claimed in claim 9, said pet toy further including:
a plurality of openings formed through said body.

13. The method, as claimed in claim 9, said pet toy further including:
a chamber formed in said body, said chamber sealed by a removable cap.

14. The method, as claimed in claim 13, further including:
loading an attractant in said chamber.

15. A pet toy comprising:
a body;
a flexible extension having one end secured to said body; and
a mounting base secured to an opposite end of said flexible extension, said mounting base including a plurality of spaced prongs, each of said prongs having a stem and an arm extending substantially perpendicular to said stem, wherein said mounting base is substantially planar and said plurality of spaced prongs extend substantially perpendicular to said mounting base.

16. A pet toy, as claimed in claim 15, wherein:
said mounting base is substantially circular, at least one stem of said prongs extends radially inward, and at least one arm extends along a periphery of said mounting base.

17. A pet toy, as claimed in claim 15, further including:
an attractant loaded in a chamber of said body.

18. A pet toy, as claimed in claim 15, further including:
a plurality of openings formed through said body.

19. A pet toy, as claimed in claim 15, further including:
a removable cap secured to said body.

20. A pet toy, as claimed in claim 19, further including:
threads on said cap that engage threads of said body.
